(19) United States
(12) Patent Application Publication
(10) Pub. No.: US 2026/0051244 A1
(43) Pub. Date: Feb. 19, 2026

(54) SYSTEM

(71) Applicant: SOFTBANK GROUP CORP., Tokyo (JP)

(72) Inventor: Yuya OGAWA, Tokyo (JP)

(73) Assignee: SOFTBANK GROUP CORP., Tokyo (JP)

(21) Appl. No.: 19/299,594

(22) Filed: Aug. 14, 2025

(30) Foreign Application Priority Data
Aug. 16, 2024 (JP) 2024-137245

(51) Int. Cl. G08G 1/08; G06V 20/54

(52) U.S. Cl. CPC G08G 1/08; G06V 20/54

(57) ABSTRACT

A system includes a processor that is configured to acquire traffic video, analyze the acquired traffic video to determine traffic conditions, and optimize traffic signal timing based on the traffic conditions, and apply the optimized signal timing to a traffic signal.

### CROSS-REFERENCE TO RELATED APPLICATION

This application is based on and claims priority under 35 USC 119 from Japanese Patent Application No. 2024-137245 filed on Aug. 16, 2024, which is incorporated by reference herein in its entirety.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional traffic signal control systems, fixed or pre-programmed signal timings are often used, which do not dynamically respond to real-time changes in traffic flow. As a result, these systems may cause unnecessary congestion, increase waiting times, and fail to adequately respond to sudden changes in traffic volume, pedestrian crossing, or unexpected events. Accordingly, there is a need for a system that can accurately assess real-time traffic conditions and optimize signal operations based on the actual situation.

### SUMMARY

The present invention provides a system including a processor, wherein the processor is configured to acquire traffic video, analyze the acquired traffic video to determine traffic conditions, optimize the timing of traffic signals according to the determined traffic conditions, and apply such optimized signal timing to the traffic signals. The processor can utilize image recognition algorithms to accurately analyze the traffic video, and further predict traffic conditions by pattern prediction based on historical data, thereby enabling adaptive and intelligent signal control in real time.

“Processor” means a hardware or software component, or a combination thereof, which is capable of executing instructions and performing logical operations to control the functions of the system.

“Traffic video” means image or video data captured at roadway intersections or road segments, depicting the movement of vehicles, pedestrians, and other traffic-related objects.

“Analyze” means performing data processing or assessment on acquired information, including but not limited to image recognition and extraction of relevant features to determine the presence, classification, and movement of objects.

“Traffic conditions” means measurable or observable states of traffic flow, including vehicle density, congestion status, queue lengths, pedestrian activity, speed, and related factors.

“Optimize” means calculating or selecting preferred or most suitable values, such as timing intervals, based on defined criteria or objectives, such as minimizing congestion or wait time.

“Signal timing” means the durations assigned to each phase of a traffic signal, such as green, yellow, or red light intervals, to control the movement of vehicles or pedestrians at an intersection.

“Image recognition algorithm” means a computational procedure or model, including but not limited to artificial intelligence or machine learning methods, used to detect, classify, and track objects within image or video data.

“Pattern prediction” means an analytical process or method that anticipates future events or behaviors, such as traffic flow or congestion, based on patterns extracted from current and historical data.

“Historical data” means previously collected records or information of traffic states, signals, or related events over a given period, used for reference or analysis.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

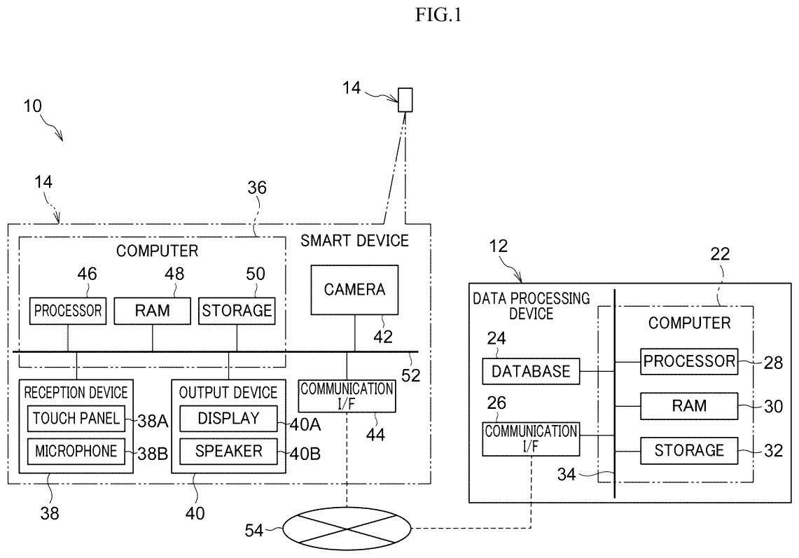

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

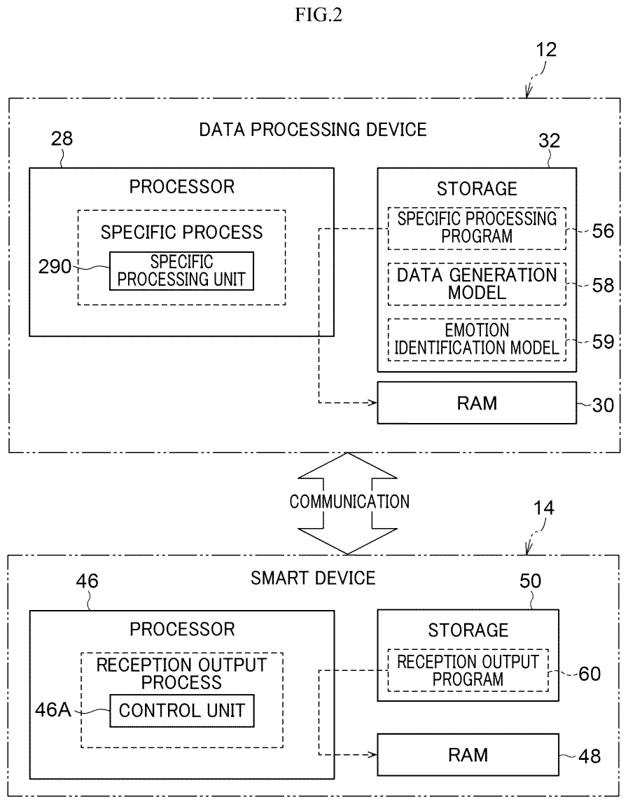

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional traffic control systems, it is difficult to adapt traffic signal timings to real-time traffic conditions, as the timings are often fixed or only manually adjustable. This frequently leads to unnecessary traffic congestion, delays, and increased risk of accidents, especially when sudden changes occur in traffic flow or during peak hours. Furthermore, existing systems lack the ability to automatically predict future traffic conditions based on both current and historical data, and cannot dynamically optimize or implement signal timing in response to actual situations in a timely and efficient manner.

The specific processing by the specific processing unit 290 of the data processing device 12 in Example 1 is realized by the following means.

The present invention provides a server including a processor configured to acquire image information from cameras, analyze the image information using deep learning-based object recognition processes, extract and store the attributes of detected objects, predict future traffic conditions through statistical analysis of current and historical data, calculate and optimize traffic signal control signals, transmit the optimized signals to control devices for real-time implementation, and provide a user interface for real-time monitoring and manual intervention. This enables automatic, accurate, and dynamic optimization of traffic control signals based on real-time and predicted traffic conditions, improving traffic flow efficiency, and allowing immediate response to unexpected events through monitoring and manual adjustment.

The term “image acquisition device” refers to a hardware device capable of capturing motion image information of a designated area, such as a camera or optical sensor system.

The term “motion image information” refers to time-sequential visual data representing the movement of objects within a scene, typically acquired as video data.

The term “encoding” refers to the process of converting motion image information into a compressed or standardized data format that facilitates efficient storage and transmission.

The term “communication network” refers to a data transmission system that enables information exchange between devices, including but not limited to wired or wireless internet infrastructure.

The term “information processing apparatus” refers to a computational device, such as a server or computer, that performs data storage, processing, and analysis.

The term “memory” refers to a physical or virtual storage medium used to save, retrieve, and manage information and data for subsequent processing.

The term “object recognition process” refers to a computational technique, typically utilizing algorithms such as deep learning or machine learning, for detecting and identifying classes of objects within motion image information.

The term “target object” refers to any entity or element, such as vehicles, pedestrians, or bicycles, that is detected and tracked within the motion image information for the purpose of traffic analysis.

The term “attribute information” refers to data describing characteristics of target objects, including but not limited to type, position, speed, direction, and size.

The term “historical statistical information” refers to accumulated data records representing past occurrences and patterns of traffic conditions at a specific location.

The term “future traffic conditions” refers to an estimation or prediction of anticipated traffic states in a given area, calculated based on current observations and historical statistical information.

The term “state control signal” refers to a digital or analog instruction transmitted to a control device to cause a physical change in the status or operation of a traffic control system.

The term “traffic control device” refers to any apparatus responsible for controlling the operational state of local traffic infrastructure, such as traffic signal controllers.

The term “monitoring and display apparatus” refers to a user-accessible device or system that visualizes real-time data and status information regarding traffic and signal control.

The term “manual change instructions” refers to commands entered by a user, typically through a user interface, to override or adjust automated control actions.

The term “information processing apparatus or control device” refers to computing systems and/or hardware components involved in processing, executing, or applying traffic signal control and user commands.

In an exemplary embodiment, the invention can be implemented as a system that optimizes traffic signal control based on real-time video analysis and predictive analytics.

The terminal is equipped with an image acquisition device, such as a high-resolution video camera, installed at a traffic intersection or along a roadway. The terminal captures motion image information continuously. The terminal encodes the video data at fixed intervals, for example every five seconds, using video compression software such as H.264 or equivalent. After encoding, the terminal transmits the processed motion image information to the server (information processing apparatus) via a communication network such as the internet. The terminal may be realized using general-purpose computing devices, single-board computers, or embedded systems with video capture capabilities.

The server is implemented as a computational platform with access to memory storage. After receiving motion image information, the server stores it and processes it using object recognition software. The server employs deep learning-based image recognition algorithms, such as those realized by open-source frameworks (for example, YOLO, OpenCV), to detect, identify, and classify target objects such as vehicles, pedestrians, and bicycles appearing in the video data. The server extracts attribute information, including type, location, direction, and speed, for each detected target object and stores the extracted data in memory for further processing.

The server further analyzes current attribute information in combination with historical statistical information, which may be stored in a database. The server applies statistical analysis, prediction, and time-series analysis to predict future traffic conditions, using algorithms or tools such as scikit-learn. Based on these predictions, the server calculates optimized state control signals for the traffic control device, such as extending or shortening signal phases in real time to mitigate predicted congestion or address changing traffic conditions.

The server transmits the optimized setting information for the state control signals to the control device (traffic signal controller). This is accomplished via the communication network, using secure communication protocols such as HTTPS and control protocols such as TCP/IP. The control device then updates the physical state of the traffic signals in accordance with the received setting information. Examples of control devices include programmable logic controllers or microcontroller-based signal controllers connected to traffic lights.

The user accesses a monitoring and display apparatus, typically provided as a web-based dashboard, to visualize real-time and historical traffic status and signal control information. The user interface enables users, such as traffic administrators, to monitor the operational status of intersections and to enter manual change instructions when necessary, such as during special events or emergencies. The server immediately processes these manual inputs and transmits new control signals to the control device to override or supplement automated adjustments.

For example, during a morning rush hour, the terminal acquires live video footage at a congested intersection. The server analyzes the video, detects an unusually high number of vehicles and pedestrians, predicts increasing congestion, and autonomously extends green signal phases while also allowing an administrator to monitor the effect and intervene through the dashboard if needed.

An example prompt sentence for a generative AI model is as follows:

“How can real-time video analysis and artificial intelligence be used to dynamically optimize traffic signal timings at urban intersections?”

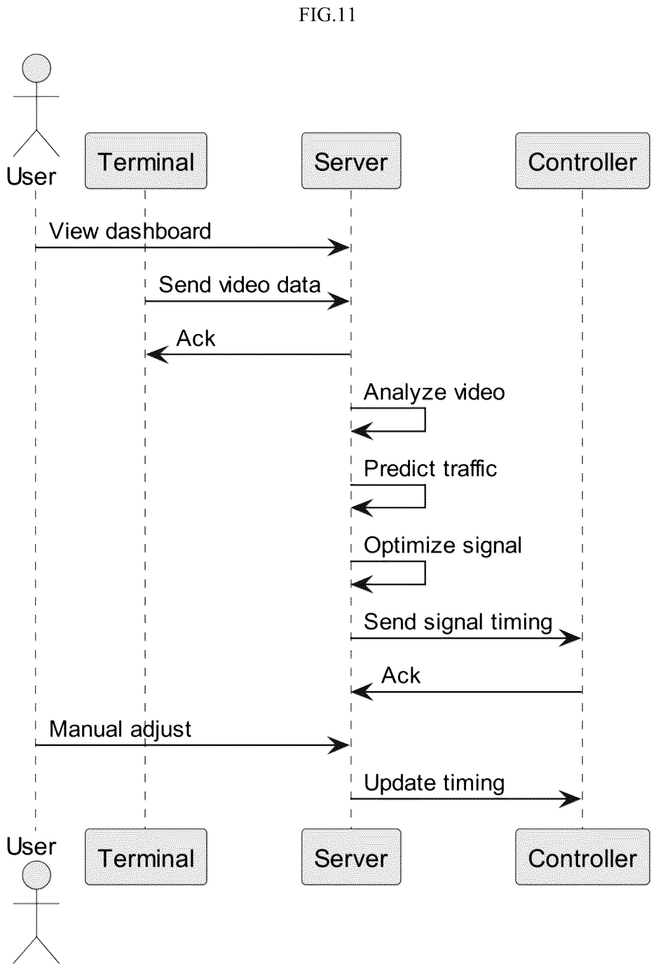

The following describes the processing flow using FIG. 11.

### Step 1:

The terminal activates an image acquisition device to continuously capture video footage of a traffic area. The input for this step is the live scene at the monitored location. The terminal encodes the acquired motion image information at regular intervals, such as every five seconds, using compression software, converting raw video frames into an encoded data stream. The output is the encoded video data, which is prepared for efficient transmission.

### Step 2:

The terminal transmits the encoded video data to the server via a communication network. The input is the encoded video data generated in Step 1. The terminal establishes a network connection and sends the video data packets to a designated server endpoint. The output is the successful delivery of encoded image information to the server.

### Step 3:

The server receives the encoded video data from the terminal through its reception interface. The input for this step is the received encoded video data. The server verifies data integrity, decodes the video stream using software such as FFmpeg, and stores the decoded motion image information in memory or a database. The output is the successfully stored and accessible raw or decoded video frames.

### Step 4:

The server analyzes the stored motion image information using an object recognition process, such as a deep learning-based detection framework (e.g., YOLO, OpenCV). The input for this step is the decoded video frames. The server executes object detection algorithms to identify and classify target objects (vehicles, pedestrians, bicycles, etc.), extracting their types, locations, speeds, and directions. The output is structured attribute data describing recognized objects within each video frame.

### Step 5:

The server collects historical statistical information from the memory and combines it with the current attribute data derived from recent frames. The input is the structured attribute data and historical traffic data related to the specific site. The server performs statistical or time-series analysis, such as regression or machine learning-based forecasting, to predict future traffic conditions, including congestion estimates. The output is prediction results indicating anticipated traffic flow for the next relevant time period.

### Step 6:

The server calculates optimized state control signals for the traffic control device based on the predicted future traffic conditions and pre-determined optimization strategies. The input is the predicted traffic conditions and operational criteria for signal optimization (such as maximizing vehicle throughput or minimizing pedestrian wait time). The server generates new timing parameters for signal phases and encodes them into a suitable format for the control device. The output is the optimized setting information for traffic control signals.

### Step 7:

The server transmits the optimized setting information to the control device (e.g., the signal controller) through the communication network. The input is the optimized signal control parameters from Step 6. The server establishes a secure network session and delivers the encoded signal control information to the device. The output is the successful update and application of new timing by the traffic control device.

### Step 8:

The user accesses a monitoring and display interface provided by the server, such as a web dashboard. The input is real-time traffic and signal information, aggregated by the server and delivered to the user interface. The user visualizes live traffic status and, if needed, enters manual control instructions for signal timing adjustments using the dashboard. The output is real-time operational feedback and, when appropriate, application of user-initiated changes to signal timing.

### Step 9:

The server receives manual control instructions issued by the user and validates their appropriateness. The input is the user's manual change request, specifying revised parameters for the signal control. The server updates the current signal timing configuration and transmits any changes to the control device for immediate execution. The output is the implementation of user-directed traffic signal changes by the traffic control device.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional control systems for traffic signals and related apparatuses are limited in their ability to adapt to real-time changes in traffic conditions, environmental factors, and the psychological status of human operators. Existing systems often lack the capacity to predict future traffic states, to optimize control settings dynamically, or to integrate operator feedback, especially based on emotion analysis, resulting in persistent congestion, inefficient traffic flow, and elevated operator stress. Therefore, there is a demand for an intelligent system that can comprehensively analyze current conditions, predict future status, optimize operational parameters accordingly, and reflect human emotional factors in control adaptation, thereby improving overall system effectiveness and safety.

The specific processing by the specific processing unit 290 of the data processing device 12 in Application Example 1 is realized by the following means.

The present invention provides a server including a processor configured to acquire imaging information, analyze the acquired imaging information to extract attribute information of a moving object or a person, generate state information based on the attribute information and record information, predict a future state using the state information and the record information, optimize the operation state of a control apparatus based on the state information and prediction information, apply optimized operation state information to the control apparatus, obtain emotion information based on expression information or voice information of an operator, fine-tune the operation state of the control apparatus based on the emotion information, provide the optimized operation state information to an external device, and enable the operator to monitor and manually adjust the operation state information via an information display apparatus. This enables the system to respond adaptively and intelligently to real-time and predicted environmental and human factors, ensuring smooth, efficient, and safe operation of the control apparatus.

The term “imaging information” refers to data representing captured visual scenes, such as video frames or still images, acquired from an imaging device including a camera or similar optical sensor.

The term “attribute information” refers to descriptive data extracted from imaging information, indicating properties and characteristics of detected objects, such as position, velocity, classification, or movement direction.

The term “moving object” refers to any item captured in imaging information that exhibits motion within the scene, including but not limited to vehicles, bicycles, and other transport means.

The term “person” refers to a human being detected and recognized in imaging information by the system.

The term “state information” refers to aggregated data representing current or recent conditions or status of a monitored environment or controlled system, derived from attribute information and record information.

The term “record information” refers to historical or logged data relating to past events, object behavior, control actions, or environmental conditions, stored by the system for analysis and prediction.

The term “prediction information” refers to information generated by analyzing state information and record information in order to forecast probable future states or events.

The term “control apparatus” refers to any device or equipment whose operational status can be adjusted by the system, such as but not limited to a traffic signal control device.

The term “operation state” refers to a setting or mode of a control apparatus, representing the timing, sequence, or configuration of its functions.

The term “external device” refers to a system or apparatus outside of the primary control domain that receives data or instructions from the server, including, for example, an autonomous vehicle or roadside communication system.

The term “operator” refers to a person who supervises, monitors, or interacts with the system through a user interface or information display apparatus.

The term “expression information” refers to data related to a person's facial expressions or physical gestures, acquired from imaging information using image analysis techniques.

The term “voice information” refers to data representing audio signals, particularly human speech or utterances captured by a microphone or similar sensor.

The term “emotion information” refers to indicators of psychological or affective states of a person, such as stress, frustration, calmness, or satisfaction, derived from expression information and/or voice information using emotion recognition technology.

The term “fine-tune” refers to a process of making minor or incremental adjustments to operation state parameters to achieve improved performance or to reflect additional input such as emotion information.

The term “information display apparatus” refers to a hardware or software interface that presents state information, operation state information, emotion information, and controls to the operator, such as a dashboard on a computer monitor or mobile device.

The invention may be implemented as an intelligent control system including a server, at least one terminal, and a user interface. The purpose of the system is to acquire imaging information, analyze and predict environmental states, optimize operation states of control apparatuses such as traffic signal devices, and integrate operator emotion as feedback for further system tuning.

The terminal is equipped with an imaging device, for example, a high-resolution network camera. The terminal continuously acquires imaging information at target locations such as street intersections or other monitoring points. The terminal is further provided with a communication module allowing reliable transmission of imaging information to the server, for example, through wireless networks like LTE or 5G. The terminal may preprocess data through compression and timestamping before transmission.

The server is realized with general-purpose computer hardware having high computational resources and a network interface. The server employs software components such as an operating system, database software (e.g., an open-source relational database system), and middleware for networking. For imaging information analysis, the server utilizes an image processing library such as OpenCV and applies a machine learning model, for instance, TensorFlow-based detection algorithms. The server extracts attribute information from imaging data, identifying moving objects and persons, and calculating properties such as position, velocity, and classification.

The server generates state information based on extracted attributes and record information stored in its memory or database. Predictive analytics are performed by the server using historical record information and state information, leveraging prediction models (such as those implemented using scikit-learn, TensorFlow, or other similar frameworks) to forecast traffic congestion or other future states.

Based on state information and prediction information, the server optimizes operation states of control apparatuses, for instance, determining the optimal timing for each traffic signal phase. Optimization procedures may utilize operations research libraries or built-in mathematical optimization frameworks.

Emotion information is captured from the operator (user) who monitors the operation through an information display apparatus such as a dashboard application (implemented using a software framework like React.js). Operator emotion may be detected by the server using emotion recognition technologies, such as image analysis of facial expressions (by an open-source library), or voice analysis (by a tone analyzer module), using data captured from a camera or a microphone.

The server collects emotion information and may fine-tune the operation state of the control apparatus accordingly to reduce operator stress or respond to perceived dissatisfaction. The optimized operation state information is then transmitted to terminals and may be further provided to external devices such as autonomous vehicles via vehicle-to-infrastructure communication protocols.

The operator is able to supervise system output, monitor real-time state information, operation state information, and emotion information on the display apparatus, and, when appropriate, initiate manual adjustments to system parameters in case of abnormal situations or emergencies.

A concrete example of usage is as follows:

During the morning rush hour, the terminal at a selected intersection captures video and sends this imaging information to the server at regular intervals. The server analyzes the video, identifying a higher-than-usual number of vehicles and pedestrians. Using historical record information, the server predicts further congestion in the next few minutes and optimizes the traffic signal phases accordingly, extending green and pedestrian phases as needed. The optimized parameters are communicated to the controlling terminal and thus to the signal device. The operator monitors the process via a dashboard, and the emotion engine detects whether the operator becomes stressed as congestion is relieved or intensifies. If necessary, the server further tunes its optimization and may provide additional alerts or notifications.

An example of a prompt sentence for generative AI model input is as follows:

During the evening rush hour, the terminal at a main intersection captures video using a high-resolution camera and transmits data every 5 seconds to the server. The server analyzes each video frame using an image processing module and a detection model to identify vehicles and pedestrians. When severe congestion is detected, the server optimizes the signal timings so that the green phase is extended by 25 seconds and the pedestrian crossing time by 12 seconds. The terminal receives and implements the new timings. The operator's dashboard reflects these changes, and if the emotion engine detects continued operator stress, the server makes further adjustments. An autonomous vehicle in the area receives newly optimized signal data and modifies its route accordingly. How can this system utilize a generative AI model to dynamically compose traffic information messages for various users?

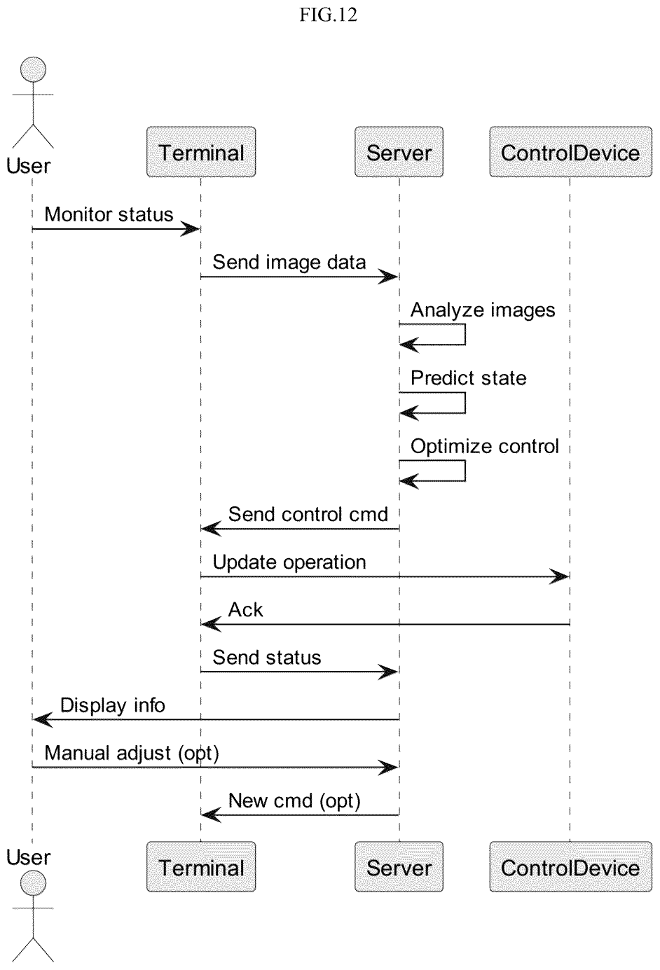

The following describes the processing flow using FIG. 12.

### Step 1:

The terminal captures real-time imaging information using an imaging device such as a high-resolution network camera installed at a designated location. The input is the scene at the monitored location, and the output is a stream of captured image or video data. The terminal compresses the video data using a standard codec and adds metadata including a timestamp and terminal identifier before storing it temporarily.

### Step 2:

The terminal transmits the compressed and tagged imaging information to the server through a wireless communication network such as LTE or 5G. The input is the image or video data generated in Step 1, and the output is a transmitted data packet sent to the server. The terminal ensures that the data packet is correctly formatted and initiates retransmission protocols if transmission errors occur.

### Step 3:

The server receives the transmitted imaging information via a network interface and writes the raw data into a temporary buffer for processing. The input is the data packet received from the terminal, and the output is buffered video or image data ready for analysis. The server validates the integrity and timeliness of the data, flagging any anomalies.

### Step 4:

The server preprocesses the buffered imaging information using software such as OpenCV, which may include resizing video frames, adjusting color, and normalizing for further analysis. The input is raw video or image data from the buffer, and the output is preprocessed frame data. Data processing includes decoding the video stream and extracting frames at predetermined time intervals.

### Step 5:

The server performs object detection on the preprocessed frame data using a machine learning model, such as a convolutional neural network implemented with TensorFlow. The input is the processed video frames, and the output is a list of detected moving objects or persons along with their attribute information (position, velocity, direction, and class). The server uses this detection output to accumulate object movement records over a specified time window.

### Step 6:

The server aggregates attribute information and generates state information by analyzing object counts, average velocities, and queue lengths at the monitored area. The input is the detection and tracking results from Step 5, and the output is current state information representing the present conditions of the location. The server stores this information in a database for further retrieval and analysis.

### Step 7:

The server analyzes both the newly generated state information and historical record information stored in the database, applying prediction processing using a model implemented with frameworks like scikit-learn or TensorFlow. The input is both the current state and relevant historical data, and the output is prediction information indicating an expected future state (such as predicted congestion levels in the next five minutes). The server adjusts the prediction model with real-time learning if necessary.

### Step 8:

The server determines the optimal operation state for the control apparatus, such as a traffic signal, using an optimization algorithm or control logic module. The input is the state information and prediction information, and the output is optimized operation state information (such as signal timing settings for each phase). The server further checks for any external constraints or emergency override requirements.

### Step 9:

The server formats the optimized operation state information into a command message and transmits this to the terminal responsible for control apparatus operation. The input is the optimized parameters, and the output is a digitally signed, protocol-compliant control message sent to the terminal. The server logs the sending event for traceability.

### Step 10:

The terminal receives the control command from the server and applies the new operation state to the control apparatus using its built-in control functions. The input is the control message from the server, and the output is the updated operational setting on the physical apparatus, such as revised signal phase durations. The terminal then sends back a status confirmation to the server.

### Step 11:

The user monitors real-time state information, operation state information, and optionally, emotion information on an information display apparatus such as a dashboard. The input is the collected monitoring data, and the output is real-time visual displays and alert notifications. The user can view trends, receive warnings, and confirm system performance.

### Step 12:

The user is observed by a camera or microphone, and expression information or voice information is acquired. The emotion engine, deployed on the server, processes these inputs to determine operator emotion information. The input is facial expression data and/or audio data, and the output is an estimate of the operator's emotional state (such as stress or satisfaction) provided for system feedback.

### Step 13:

The server collects the emotion information and decides whether to fine-tune the operation state based on high operator stress or other emotional cues. The input is the operator emotion information, and the output is an adjusted optimization routine or parameter update. The server can thus dynamically adapt operation states to improve both system and human-factor performance.

### Step 14:

The user can manually intervene in the system, for example, by adjusting operation state parameters from the dashboard in response to emergencies or events not handled by automated processes. The input is the user's manual adjustment request, and the output is a new control command sent to the control apparatus via the server. The server validates and applies these overrides, then restores automated control as appropriate.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional traffic control systems, the optimization of signal timing is primarily based on the analysis of traffic flow and congestion. However, these systems fail to incorporate user psychological states such as stress or frustration, which may result in user dissatisfaction even when traffic flows smoothly. Furthermore, real-time integration of diverse data sources-including video analysis, user emotion recognition, and historical pattern forecasting-into actionable signal control remains technically challenging. There is a need for a traffic management system that can not only optimize signal timing with high accuracy based on a wide variety of dynamic data but also reduce psychological burden on users.

The specific processing by the specific processing unit 290 of the data processing device 12 in Example 2 is realized by the following means.

The present invention provides a server including a processor configured to acquire chronological image data of a traffic space, analyze the data to identify and track vehicles, pedestrians, and non-motorized objects using object detection and artificial intelligence models, dynamically optimize signal control timing based on movement characteristics and historical data, estimate user psychological states based on biometric information, and reflect emotional analysis in timing optimization, while also enabling manual adjustment via an interactive interface. This enables highly accurate, real-time signal control that considers both the physical traffic environment and human psychological factors, resulting in smoother traffic flow and reduced user stress.

The term “chronological digital data” refers to digital information representing a sequence of images or recordings acquired over time from a monitored traffic environment.

The term “imaging device” refers to a hardware component, such as a camera, configured to capture visual information of a given area and convert it into digital images or video data.

The term “traffic space” refers to a physical environment in which transportation participants, such as vehicles, pedestrians, and non-motorized moving objects, interact or move.

The term “object detection information processing” refers to computational techniques that use algorithms or artificial intelligence models to identify and locate objects within acquired image data.

The term “traffic constituents” refers to entities that participate in or affect traffic flow, including vehicles, pedestrians, and non-motorized moving objects such as bicycles.

The term “movement characteristic information” refers to attributes extracted from detected objects, such as position, speed, direction, and flow rate, that describe the dynamic behavior of traffic constituents.

The term “historical information” refers to accumulated data about past traffic conditions and dynamic behaviors recorded by the system.

The term “signal control timing” refers to the duration and sequence by which a signaling device, such as a traffic light, displays different signal states to control the movement of traffic constituents.

The term “light display device” refers to an apparatus, such as a traffic signal, equipped with light sources intended to convey control information to traffic constituents.

The term “communication network” refers to a system or infrastructure that enables the transmission of data between the processor, the light display device, and other system components.

The term “biometric information acquisition device” refers to any sensor or apparatus, including cameras or microphones, used to collect information about the physiological or behavioral state of a user.

The term “psychological state” refers to the emotional or mental condition of a user, including but not limited to stress, frustration, or satisfaction, as inferred from biometric inputs.

The term “monitoring device” refers to hardware or software used to visualize, aggregate, and present real-time and historical traffic and psychological information.

The term “interactive input device” refers to a user interface component which allows an administrator or user to manually input commands or adjustments to the system.

The term “artificial intelligence model” refers to a computational framework or algorithm capable of extracting, classifying, or predicting patterns from input data, especially for object detection and behavior analysis.

The term “history analysis device” refers to a processor or software module configured to analyze and extract trends or predictions from historical traffic data.

### Embodiment for Implementing the Invention

The present invention may be embodied as an integrated traffic management system including a terminal (such as a traffic camera unit), a server (capable of distributed or cloud-based processing), and a user interface (dashboard for administrators). The system is configured to acquire, process, and analyze chronological digital image data of a traffic space; extract movement characteristics of traffic constituents using object detection by artificial intelligence models; incorporate user psychological states inferred from biometric data; optimize signal control timing based on both physical and psychological data; and enable interactive manual adjustment and visualization.

The terminal is equipped with an imaging device, such as a network camera, which captures digital video images of intersections or road segments at specified time intervals (e.g., 30 frames per second). The terminal preprocesses the images, resizing and compressing video data using software such as an H.264 codec. For multi-modal sensor integration, microphones or additional cameras may be added to acquire audio and facial expression data for emotion analysis.

The terminal transmits the compressed, time-stamped image and biometric data securely to the server via a communication network, using protocols such as SSL/TLS for video transfer and MQTT for low-latency transmission of control commands.

The server receives and decodes chronological image data. It applies artificial intelligence models for object detection and classification; examples include YOLO (You Only Look Once) or similar models implemented with the OpenCV library. The server determines the number, type, position, speed, and direction of various traffic constituents, such as vehicles, pedestrians, and non-motorized objects.

The server analyzes historical data stored in a data storage device, such as a PostgreSQL or similar database, to recognize traffic trends and predict future traffic dynamics. Based on current and predicted traffic density and flow, the server dynamically optimizes the signal control timing by calculating the phase durations for each signal (green, yellow, red) at each controlled intersection.

Biometric information, including user voice and facial expressions collected by the terminal, is analyzed using emotion recognition algorithms. Generic application programming interfaces (APIs) for emotion recognition may be used, such as those provided by major cloud platform providers, but any general recognition engine can be substituted. The server integrates the recognized psychological state (e.g., stress level) into the signal timing optimization logic. For example, if a high level of user stress is detected, the server may reduce the red-light phase to decrease frustration for waiting drivers or pedestrians.

The optimized signal control timing is transmitted from the server to the terminal through a communication network. The terminal receives these timing updates and controls the display state of the traffic light (e.g., using LED arrays or relay-driven signal heads) accordingly and in real time.

A monitoring device, such as a user-accessible dashboard created with web technologies, aggregates and visualizes traffic conditions and psychological state data for the administrator. The user reviews live metrics and historical trends. An interactive input device, such as a graphical user interface, allows the administrator to make manual adjustments-such as changing the duration of the green phase in emergency situations. These manual settings are immediately forwarded to the server, which in turn updates the terminal settings.

For example, during the morning rush, the terminal captures heavy congestion and submits video data to the server. The server detects a high density of vehicles and queues, and predicts that congestion will increase over the next five minutes. The server extends the green phase for vehicles to improve traffic flow, and, upon detecting high user stress from voice and facial data, it further refines the timing. The user supervises the results on the dashboard and can override the timing if necessary.

### Example Prompt Sentence:

Analyze the current traffic video data and write a program that optimizes signal timings. Specifically, for intersection A, where there are 50 vehicles and 30 pedestrians, extend the green signal for vehicles by 10 seconds and shorten the pedestrian signal by 5 seconds. Additionally, use emotion data to further fine-tune the signal timing.

The invention is thus implemented by combining commonly available hardware such as network cameras, microphones, servers with general-purpose processors or graphical processing units, and standard networking equipment. Software used can include H.264 codecs for compression, communication libraries supporting SSL/TLS and MQTT, object detection and recognition models (e.g., those built on OpenCV or equivalent machine learning frameworks), emotion recognition APIs, and web application frameworks for the administrator dashboard. This integration enables accurate, adaptive, and psychologically aware traffic signal control.

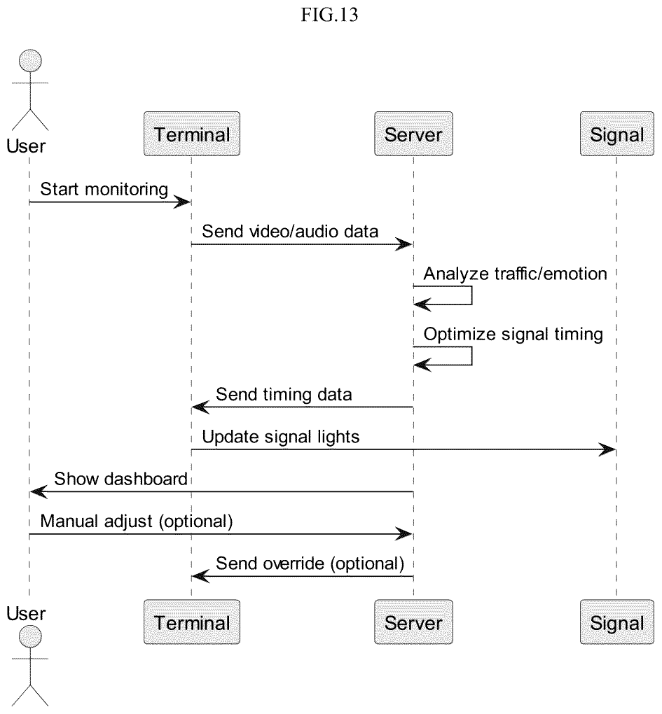

The following describes the processing flow using FIG. 13.

### Step 1:

Terminal captures real-time video footage and audio data from the traffic environment using a camera and microphone. The input to this step is the live environment itself, and the output is a sequence of image frames (e.g., 30 frames per second) and audio waveforms. The terminal preprocesses the video by resizing frames to a standardized resolution (e.g., 640×480 pixels) and compresses the video stream with an H.264 codec. The terminal also digitizes audio input and synchronizes both data streams with timestamps.

### Step 2:

Terminal transmits the compressed video and audio data to the server via a secure network connection. The input is the time-stamped, compressed multimedia data, and the output is an encrypted data packet sent over SSL/TLS protocol. The terminal gathers the data into packets every one second and ensures reliable data transfer by using re-transmission mechanisms in case of packet loss.

### Step 3:

Server receives and decodes the incoming data from the terminal. The input is the encrypted multimedia packet, which the server decrypts and decompresses into a raw sequence of image frames and audio samples. The output is a set of video frames and clear audio streams available for further analysis. The server logs the received data with identifiers for intersection location and time.

### Step 4:

Server analyzes the video frames using an artificial intelligence object detection model (e.g., YOLO implemented with OpenCV). The input is the set of decoded video frames. The server processes each frame to detect and locate objects such as vehicles, pedestrians, and non-motorized units. The output is a list of detected objects with properties including class label, bounding box coordinates, and frame-by-frame movement vectors. Server calculates additional metrics such as traffic density, object speed, and queue lengths by tracking object movement across frames.

### Step 5:

Server analyzes audio and facial image data to recognize user emotions by calling a generic emotion recognition API. The input to this step is the audio waveform and facial image segments extracted from frames. The server sends this data to the emotion recognition engine, which returns emotion scores (such as stress or frustration levels) for each data segment. The output is an aggregated psychological state profile associated with a specific time and location.

### Step 6:

Server integrates traffic flow data and user emotion data to generate a current traffic state profile. The input is the traffic feature list and emotion scores from previous steps. The server aggregates and summarizes these values, producing a unified traffic-environmental and psychological data table. The output is a comprehensive state profile for the monitored area, stored in a database for real-time reference and historical analysis.

### Step 7:

Server predicts short-term traffic conditions based on the current traffic state profile and historical data using a predictive algorithm. The input is the current state profile and records from the historical database. The server generates a five-minute forecast of vehicle and pedestrian volumes and calculates expected queue developments. The output is a time series of predicted traffic state values for each monitored point.

### Step 8:

Server optimizes signal control timing based on both the immediate and predicted traffic data as well as aggregated emotion scores. The input is the predicted and current traffic state together with emotion analysis results. The server runs an optimization algorithm to determine the best signal phase durations (green, yellow, red) to maximize flow and minimize user stress. The output is a set of new signal timing parameters, formatted as a JSON object.

### Step 9:

Server transmits the optimized signal timing parameters to the terminal's traffic light controller using the MQTT protocol. The input is the JSON signal timing data. The server ensures that the timing data reaches the correct terminal and logs successful transmission. The output is confirmation that the signal control settings are received by the terminal.

### Step 10:

Terminal receives the new signal timing data, parses it, and controls the hardware of the traffic light apparatus to implement the updated phase durations. The input is the JSON signal timing parameters received over MQTT. The terminal adjusts the duration of green, yellow, and red lights per the server's calculation and logs every transition with a timestamp. The output is the real-world change in the traffic signal sequence at the intersection.

### Step 11:

User monitors the traffic and emotion data as well as the current and past signal timings through a web-based dashboard. The input is a live data feed and historical records provided by the server, displayed via the dashboard interface. The user reviews system performance in real time, detects anomalies, and may decide to override automated control in special situations.

### Step 12:

User manually adjusts signal timing by interacting with the dashboard's graphical interface. The input is the user's desired phase settings, which are sent as override commands to the server. The server validates the request and forwards new signal timing data to the terminal. The output is the immediate alteration of signal timing at the intersection as per user preference, and the update is logged for later review.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional control systems for public infrastructure or mobile bodies, such as traffic management systems or autonomous vehicle operations, real-time optimization has primarily focused on objective environmental data, such as images and sensor signals. However, these systems often neglect the subjective state or emotional feedback of users, which can impact the overall safety, satisfaction, and flow of traffic or facility use. Additionally, there is a lack of integrated technology that can reflexively adjust operations according to both objective environmental conditions and the emotional or physiological state of users in real time, particularly in environments involving autonomous mobility. The challenge is to provide a system that can dynamically and adaptively optimize operational control based on comprehensive, real-time analysis of both environment and user status.

The specific processing by the specific processing unit 290 of the data processing device 12 in Application Example 2 is realized by the following means.

The present invention provides a server including a processor configured to acquire environment information, analyze the acquired environment information to determine usage conditions, optimize the operation of a control device based on the determined usage conditions, apply the optimized control operation to the control device, analyze biometric information or emotional information obtained from a user, finely adjust the operation of the control device in accordance with the analyzed biometric information or emotional information, and optimize the driving operation of a mobile body based on the environment information acquired by an acquiring unit provided in the mobile body. This enables dynamic integration and real-time optimization of control operations by considering both objective environmental data and subjective user feedback, thereby improving safety, efficiency, and user comfort in control systems such as traffic management and autonomous vehicle environments.

The term “environment information” refers to data representing physical conditions or external situations, including but not limited to video images, sound signals, sensor data, weather conditions, or traffic status collected from the surroundings of a target area or moving object.

The term “usage conditions” refers to the status or pattern of operation, presence, or flow of people, vehicles, or objects within a specific environment, as determined based on environment information.

The term “control device” refers to an apparatus, system, or component capable of adjusting or regulating the operation, state, or output of equipment such as traffic signals, lighting, climate control, or vehicle actuators.

The term “biometric information” refers to any data that represents physical or physiological characteristics of a user, such as voice, facial expressions, heart rate, or other biological signals.

The term “emotional information” refers to data indicating the psychological state, feeling, or disposition of a user, which can be inferred from characteristics such as tone of voice, facial expression, or behavioral cues.

The term “mobile body” refers to any movable platform or vehicle, including but not limited to autonomous automobiles, buses, drones, or robots, which moves within an environment and can act based on perceived inputs.

The term “acquiring unit” refers to a component or subsystem that collects, detects, or obtains environment information or biometric/emotional information, such as a camera, microphone, or other sensor.

The term “optimize” refers to the process of calculating, adjusting, or determining a parameter, action, or configuration that is intended to improve performance, efficiency, safety, comfort, or other desired attributes, based on one or more inputs.

The term “server” refers to an information processing apparatus, including its hardware and software components, configured to control, analyze, or coordinate other devices, to perform the functions described in the claims.

The invention can be implemented as a control system integrating a server, one or more terminals, and users. The server is equipped with a processor and storage, and runs dedicated software to acquire, process, and analyze data from various sources. The hardware used includes general computing equipment, imaging sensors such as digital cameras, microphones, biometric sensors, and control apparatus for traffic infrastructure or mobile bodies. Software used in the embodiment may include image analysis libraries (such as OpenCV), machine learning frameworks (such as TensorFlow), middleware for distributed robotic systems (such as ROS: Robot Operating System), and custom Python scripts for data aggregation and control logic.

The server acquires environment information using terminals equipped with data-gathering sensors. For example, a camera positioned at an intersection (which may be a network security camera) sends real-time video to the server. The server preprocesses the incoming data using OpenCV to format and normalize the images. TensorFlow or similar frameworks may be used to perform object detection and classification within the video frames, extracting useful features such as vehicle location, pedestrian movement, or the presence of specific conditions in the monitored environment.

The server analyzes the processed environment information to determine the current usage conditions, such as congestion levels or flow efficiencies around the intersection. The server also receives or collects biometric or emotional information from one or more users. For instance, a terminal installed in a vehicle may capture audio of passenger speech or collect facial images, which it transmits to the server or an associated emotion processing unit. The server then applies a pretrained machine learning model—or invokes an external emotion analysis API—to determine a user's emotional state. These results are integrated into the overall assessment by the server.

Based on the combined analysis of environment and user information, the server calculates optimized parameters for the operation of a control device, such as the timing and duration of a traffic signal phase or operating policy for mobile bodies like autonomous vehicles. The server transmits the control instructions, via a communication interface, to the relevant target devices (such as a traffic controller or the onboard computer of a mobile body). If negative biometric or emotional responses are detected from users, the server may finely adjust its control strategy by, for example, reducing waiting time for specific lanes or modifying vehicle speed to improve user comfort and safety.

As a specific example, the system can be configured so that a camera at a road intersection captures video which is transmitted to the server for analysis. The server detects unusually high congestion and determines that many users waiting at the intersection are expressing frustration or stress, as detected via in-vehicle terminal microphones. The server then calculates new timing for the signal based on both objective congestion levels and subjective user feedback, applying the change to the traffic controller. An autonomous vehicle's onboard system receives processed traffic and emotional feedback over the network, and optimizes its route and speed using ROS middleware based on the received data.

This invention may also utilize prompt sentences for a generative AI model to facilitate system integration. For example, the following prompt can be used:

“Given real-time traffic video and user audio data, use OpenCV and TensorFlow to detect and track all vehicles, bicycles, and pedestrians, and also extract emotion labels from user voice. If you identify congestion and user frustration, optimize and fine-tune the timing of the traffic signals accordingly. Coordinate these actions using Python scripts and ROS for communication with autonomous vehicles.”

This embodiment achieves dynamic and comprehensive optimization of control systems in environments affected by both physical conditions and human factors, and can be adapted to a variety of applications such as traffic management, smart infrastructure, and autonomous transportation.

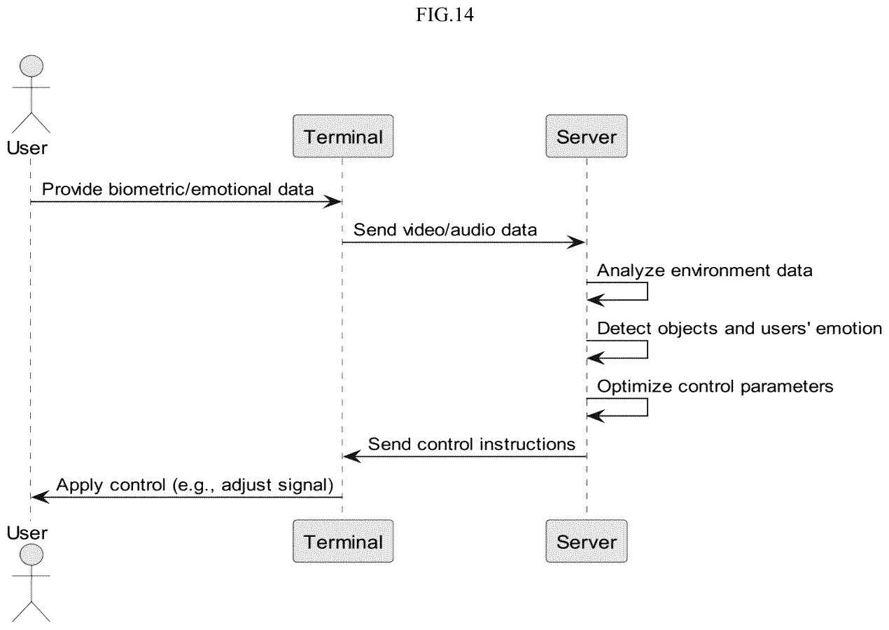

The following describes the processing flow using FIG. 14.

### Step 1:

Terminal acquires environment information by capturing real-time video data from cameras installed at intersections and by collecting audio and facial images from in-vehicle sensors.

Input: Live video stream from imaging sensors; audio and facial data from interior vehicle sensors.

The terminal digitizes, encodes, and packages this information for secure transmission.

Output: Streamed environment and user data sent to the server.

### Step 2:

Server receives the video, audio, and biometric data streams from multiple terminals.

Input: Encoded video, audio, and biometric streams from terminals.

The server buffers the incoming data, decodes the streams, and segregates different data types for subsequent processing.

Output: Raw video frames, separate audio tracks, and biometric datasets stored in memory.

### Step 3:

Server analyzes video frames using image analysis software such as OpenCV and applies a trained machine learning model such as TensorFlow to detect and classify objects (e.g., vehicles, pedestrians, bicycles) present in each frame.

Input: Video frames from Step 2.

The server performs object detection, assigns bounding boxes, and creates object lists with identities, positions, and classifications.

Output: Structured object detection output (such as JSON or tables with object categories, positions, and timestamps).

### Step 4:

Server processes successive frames to track each detected object and calculate its speed and direction.

Input: Structured object detection data from Step 3.

The server compares object positions over time, calculates velocity vectors, and organizes flow patterns for traffic analysis.

Output: Aggregated movement profiles for each object, including position, speed, direction, and persistence.

### Step 5:

Server analyzes aggregated movement profiles to determine usage conditions, such as congestion level, wait times, and flow bottlenecks in the monitored area.

Input: Object movement profiles from Step 4.

The server evaluates overall traffic status, identifies abnormal congestion or safety risks, and labels zones accordingly.

Output: Usage condition data, including congestion indicators and traffic recommendations.

### Step 6:

Server analyzes audio and facial data using the emotion recognition model, such as a neural network trained for emotion inference, to extract biometric or emotional information from users.

Input: Audio and facial data from Step 2.

The server processes the data, infers emotional states (e.g., frustration, calmness, stress), and generates an emotional profile for each identified user.

Output: User emotion labels with corresponding confidence scores.

### Step 7:

Server integrates usage condition data and user emotional profiles to generate optimized control parameters for operation of signal controllers or mobile bodies.

Input: Usage condition data from Step 5 and emotion profiles from Step 6.

The server runs an optimization algorithm, adjusting timings (e.g., signal phase durations) or operational strategies based on both traffic status and user state.

Output: Control device operation parameters and mobile body action instructions.

### Step 8:

Server transmits optimized control instructions to the appropriate terminal for application to the control device or guidance to the mobile body.

Input: Control parameters or action instructions from Step 7.

The terminal receives these instructions, updates the state of the control device (such as a traffic signal), or delivers new navigation parameters to a mobile platform.

Output: Real-time adjustment of traffic infrastructure or vehicle operation.

### Step 9:

User experiences the updated system control, such as reduced wait times at intersections or improved vehicular ride comfort, as a result of the feedback and adaptive control process.

Input: Adjusted environment and device conditions from Steps 7 and 8.

User behavior and emotional status may change, and new data is generated for the next operational cycle.

Output: Real-world feedback loop feeding ongoing system optimization.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

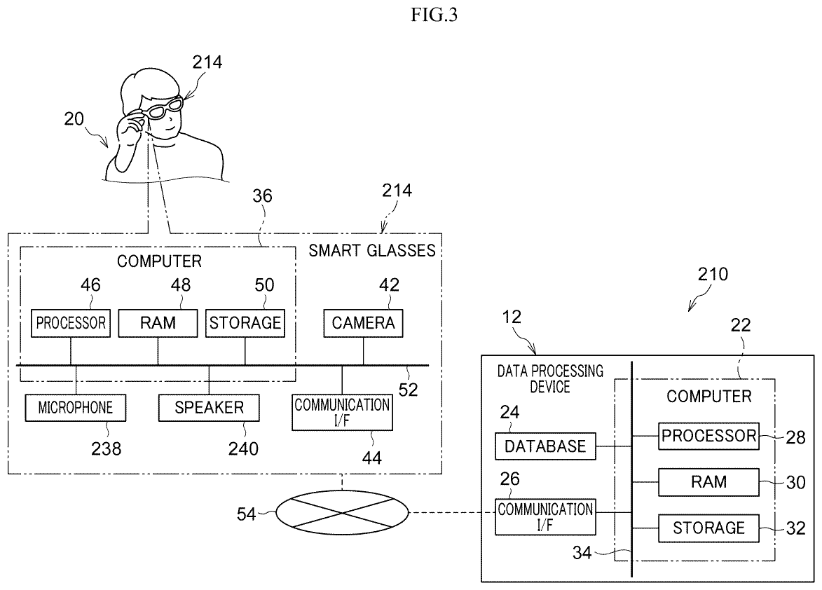

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

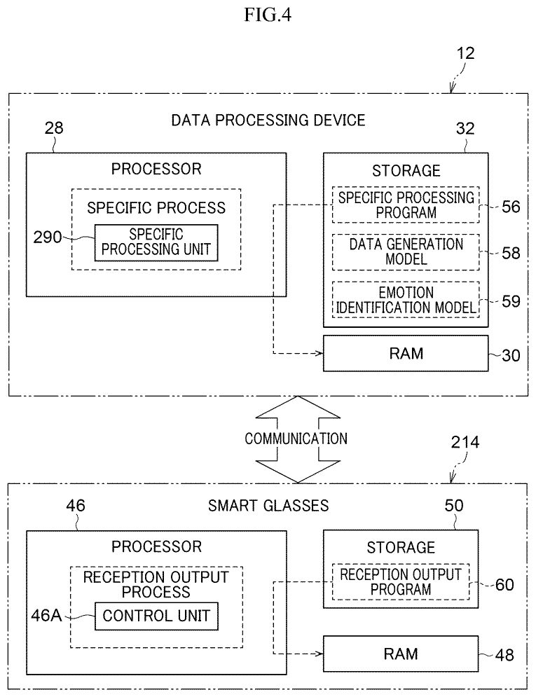

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

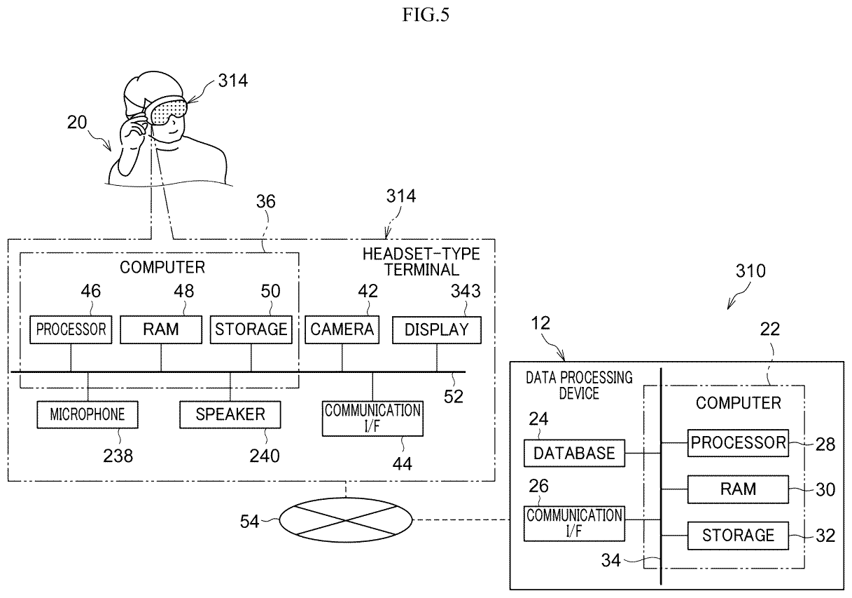

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

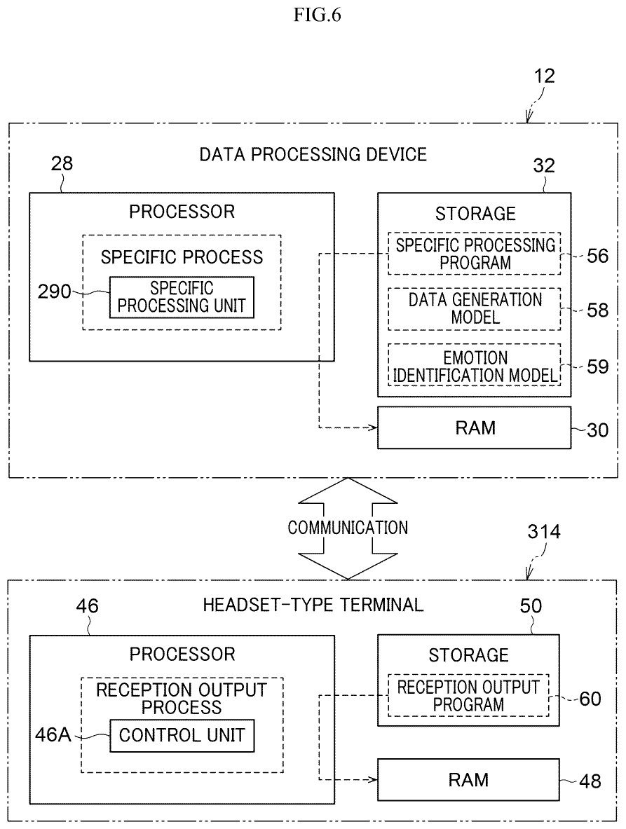

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

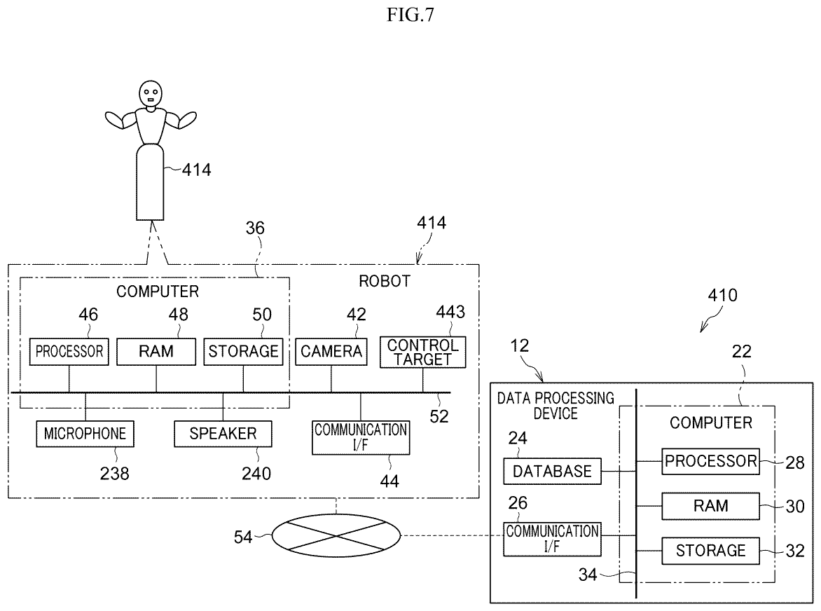

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

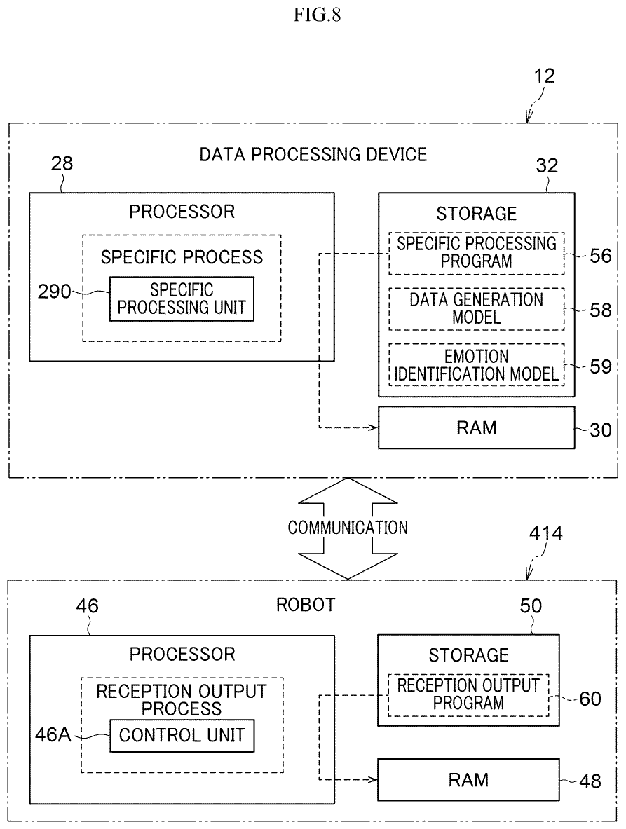

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

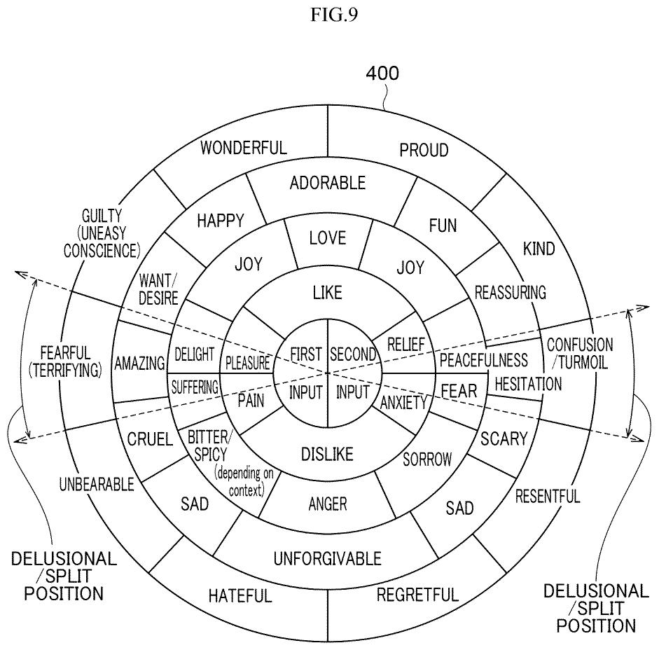

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

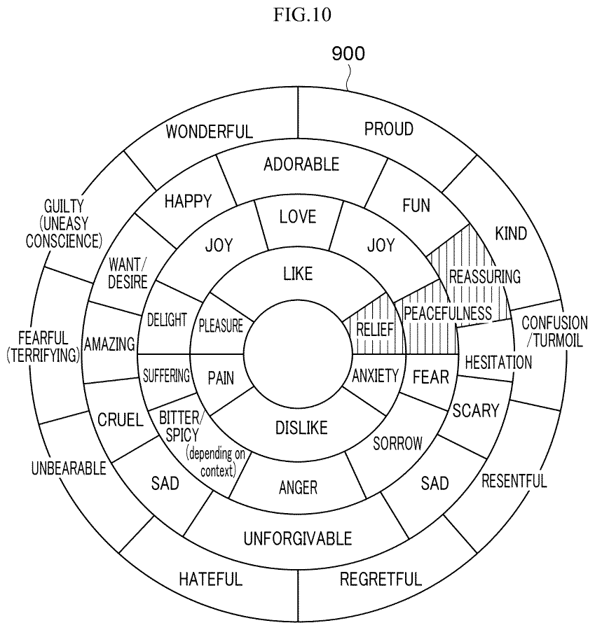

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system including a processor,
wherein the processor is configured to
acquire motion image information from an image acquisition device installed at a site, encode the motion image information at predetermined intervals, and transmit the encoded data to an information processing apparatus via a communication network;
store the received motion image information in a memory, analyze the motion image information by using an object recognition process to identify target objects such as moving bodies or pedestrians, and extract attribute information of the identified objects;
predict future traffic conditions by analyzing the attribute information and historical statistical information stored in the memory, and calculate optimized state control signals for a traffic control device;
transmit setting information of the optimized state control signals to a control device via the communication network, causing the control device to change a physical state based on the received setting information;
and, via a monitoring and display apparatus, visualize real-time traffic and control statuses, receive manual change instructions of the control signals from a user, and immediately reflect the instructions via the information processing apparatus or the control device.

### Supplementary 2

The system according to supplementary 1,
wherein the processor is configured to use a deep learning-based image processing algorithm as the object recognition process.

### Supplementary 3

The system according to supplementary 1,
wherein the processor is configured to analyze time-series information stored in the memory with a statistical analysis process in order to generate prediction information for the future traffic condition.

### Application Example 1

### Supplementary 1

A system including a processor,
wherein the processor is configured to
acquire imaging information;
analyze the acquired imaging information to extract attribute information of a moving object or a person;
generate state information based on the attribute information and record information;
predict a future state by using the state information and the record information;
optimize an operation state of a control apparatus based on the state information and prediction information;
apply optimized operation state information to the control apparatus;
obtain emotion information based on expression information or voice information of an operator;
fine-tune the operation state of the control apparatus based on the emotion information;
provide the optimized operation state information to an external device; and
enable the operator to monitor the state information, operation state information, and emotion information using an information display apparatus and, if necessary, manually adjust the operation state information.

### Supplementary 2

The system according to supplementary 1,
wherein the processor is configured to
use image processing technology and a machine learning model for extraction of attribute information.

### Supplementary 3

The system according to supplementary 1,
wherein the processor is configured to
calculate a future state using a prediction processing model based on the state information or record information.

### Example 2

### Supplementary 1

A system including a processor,
wherein the processor is configured to
acquire chronological digital data of a traffic space by using an imaging device,
analyze the acquired chronological image data to identify traffic constituents including vehicles, pedestrians, and non-motorized moving objects based on object detection information processing, and extract movement characteristic information,
dynamically optimize signal control timing based on the movement characteristic information and historical information,
output the result of the dynamic optimization of the signal control timing to a light display device via a communication network and change the signal state,
estimate a psychological state of a user based on audio information and image information collected with a biometric information acquisition device, and reflect the estimation result in the optimization of the signal control timing,
and visualize traffic conditions and psychological state data by a monitoring device and enable manual adjustment of the signal control timing by an administrator via an interactive input device.

### Supplementary 2

The system according to supplementary 1,
wherein the processor is configured to apply an artificial intelligence model for object identification in the analysis of chronological image data to extract and classify features of the constituents.

### Supplementary 3

The system according to supplementary 1,
wherein the processor is configured to analyze historical information of past traffic conditions with a history analysis device to predict future dynamics of the constituents, and reflect the prediction in the optimization of the signal control timing.

### Application Example 2

### Supplementary 1

A system including a processor,
wherein the processor is configured to
acquire environment information,
analyze the acquired environment information to determine usage conditions,
optimize the operation of a control device based on the determined usage conditions,
apply the optimized control operation to the control device,
analyze biometric information or emotional information obtained from a user,
finely adjust the operation of the control device in accordance with the analyzed biometric information or emotional information,
and optimize the driving operation of a mobile body based on the environment information acquired by an acquiring unit provided in the mobile body.

### Supplementary 2

The system according to supplementary 1,
wherein the processor is configured to
analyze the environment information using an image recognition processing technique or a machine learning processing technique.

### Supplementary 3

The system according to supplementary 1,
wherein the processor is configured to
estimate future usage conditions based on previously acquired environment information and usage condition data.

What is claimed is:

1. A system comprising a processor that is configured to:
acquire traffic video;
analyze the acquired traffic video to determine traffic conditions;
optimize traffic signal timing based on the traffic conditions; and
apply the optimized signal timing to a traffic signal.

2. The system according to claim 1, wherein the processor uses an image recognition algorithm to analyze the traffic video.

3. The system according to claim 1, wherein the processor performs pattern prediction based on historical data in order to predict traffic conditions.
